(19) United States
(12) Patent Application Publication
(10) Pub. No.: US 2009/0127949 A1
(43) Pub. Date: May 21, 2009

(54) PERMANENT-MAGNET SYNCHRONOUS GEARLESS TRACTION MACHINE

(76) Inventors: He Zhang, Changshu (CN); Jianwen Cao, Changshu (CN); Wenna Fang, Changshu (CN); Yesheng Qu, Changshu (CN)

Correspondence Address: CHRISTIE, PARKER & HALE, LLP, PO BOX 7068, PASADENA, CA, 91109-7068, US

(21) Appl. No.: 12/235,505

(22) Filed: Sep. 22, 2008

(30) Foreign Application Priority Data
Nov. 20, 2007 (CN) 200710190637.1

(51) Int. Cl. H02K 7/10

(52) U.S. Cl. 310/77

(57) ABSTRACT

A permanent-magnet synchronous gearless traction machine. The traction machine includes a permanent-magnet synchronous motor having a spindle; a traction wheel coupled to the spindle of the permanent-magnet synchronous motor; a first brake; and a second brake, wherein at least one of the first brake or the second brake is coupled to the traction wheel. As such, in the traction machine, since at least one of the first or second brakes is coupled to the traction wheel, the braking torque generated by the brake coupled to the traction wheel can brake the traction wheel directly, and thereby the operation safety of the elevator can be improved effectively.

### CROSS-REFERENCE TO RELATED APPLICATION(S)

This application claims priority to and the benefit of Chinese Patent Application Number 200710190637.1 CN, filed in the State Intellectual Property Office (SIPO) of China on Nov. 20, 2007, the entire content of which is incorporated herein by reference.

### FIELD OF THE INVENTION

The present invention relates to a traction machine that drives an elevator to move up and down, and in particular to a permanent-magnet synchronous gearless traction machine.

### BACKGROUND OF THE INVENTION

Permanent-magnet synchronous gearless traction machines are commonly seen in the market and relevant literatures. For example, a three-point permanent-magnet synchronous gearless traction machine set and a permanent-magnet synchronous high-speed gearless traction machine were introduced in China Patent Authorization Publication Nos. CN1304267C and CN1297467C. A mini-type permanent-magnet synchronous gearless traction machine was proposed in Publication No. CN1850577A. A Halbach permanent-magnet gearless traction machine; a mount mechanism and a front-support structure for a three-point permanent-magnet synchronous gearless traction machine; and a rare-earth element (REE) permanent-magnet synchronous gearless traction machine were disclosed in CN101049882A, CN2666874Y, and CN2670321Y, respectively. Also, a permanent-magnet synchronous high-speed gearless traction machine; a permanent-magnet synchronous gearless traction machine; and a permanent-magnet synchronous gearless traction machine were disclosed in CN2717906Y, CN2756601Y, and CN2825577Y, respectively. Each of the traction machines described above comprises a permanent-magnet synchronous motor, a traction wheel, and brakes, wherein the brakes are usually disk brakes connected to the permanent-magnet synchronous motor coaxially, appear as a pair (called a dual brake in the industry), and are mounted at the same position. Here, “mounted at the same position” means both of the brakes of the pair are directly connected to the spindle of the permanent-magnet synchronous motor; for example, the mini-type permanent-magnet synchronous gearless traction machine provided in CN200943027Y describes such a configuration. A permanent-magnet synchronous gearless traction machine having such a structure is difficult to ensure safety during operation of the elevator because both of the two brakes are mounted on the front or the rear extension end of the spindle of the permanent-magnet synchronous motor, away from the traction wheel, and the two brakes will act simultaneously during natural running and emergency braking (e.g., braking in case of power outage), and are not clearly distinguishable in function and duty. Therefore, in the case of emergency braking when the elevator runs upward, since the two brakes are away from the traction wheel, the braking torque can only be transferred via the spindle (also referred to as the long shaft) of the permanent-magnet synchronous motor. That is, the permanent-magnet synchronous motor must be used as a transition for braking of the traction wheel. It is proven that such an approach is not reliable in terms of safety, and cannot meet the requirement for safety of braking against over-speed up-running as specified in the national standards, and may cause compromised safety factor during operation of the elevator.

### SUMMARY OF THE INVENTION

According to embodiments of the present invention, a permanent-magnet synchronous gearless traction machine is equipped with brakes mounted at positions providing improved safety during operation of the elevator.

According to an embodiment of the present invention, a permanent-magnet synchronous gearless traction machine includes: a permanent-magnet synchronous motor having a spindle; a traction wheel coupled to the spindle of the permanent-magnet synchronous motor; a first brake; and a second brake, wherein at least one of the first brake or the second brake is coupled to the traction wheel.

In one embodiment of the present invention, the first brake is coupled to the traction wheel, and the second brake is directly connected to the spindle of the permanent-magnet synchronous motor.

In one embodiment of the present invention, the first and second brakes are coupled in parallel to the traction wheel.

In one embodiment of the present invention, the first brake is directly coupled to the traction wheel.

In one embodiment of the present invention, the first brake is not directly coupled to the spindle.

In one embodiment of the present invention, the traction wheel includes a brake receiver configured to receive the first brake at a center of a side of the traction wheel facing the first brake.

In one embodiment of the present invention, the brake receiver is integrally arranged at the center of the side of the traction wheel.

In one embodiment of the present invention, the brake receiver is fixed to the center of the side of the traction wheel.

In one embodiment of the present invention, the brake receiver has a spline on it.

As such, in the traction machine, since at least one of the first or second brakes fixed to a spindle of a permanent-magnet synchronous motor is combined with a traction wheel, the braking torque generated by the brake fitted to the traction wheel can brake the traction wheel directly, and thereby improve the operation safety of the elevator.

### BRIEF DESCRIPTION OF THE DRAWINGS

FIG. 1 is a schematic diagram of a permanent-magnet synchronous gearless traction machine according to a first embodiment of the present invention;

FIG. 2 is an exploded schematic view of a first brake and a traction wheel of the present invention; and

FIG. 3 is a schematic diagram of a permanent-magnet synchronous gearless traction machine according to a second embodiment of the present invention.

### DETAILED DESCRIPTION OF THE EMBODIMENTS

The present invention will be described herein by reference to several embodiments, in order to illustrate aspects of the present invention. These embodiments shall not be deemed as constituting any limitation to the technical scheme of the present invention. Any change to the definition of the components or technical features and/or non-essential deviations to the overall structure without departing from the spirit or scope of the present invention shall not restrict the protectable subject matter defined by the technical scheme of the present invention.

### Embodiment 1

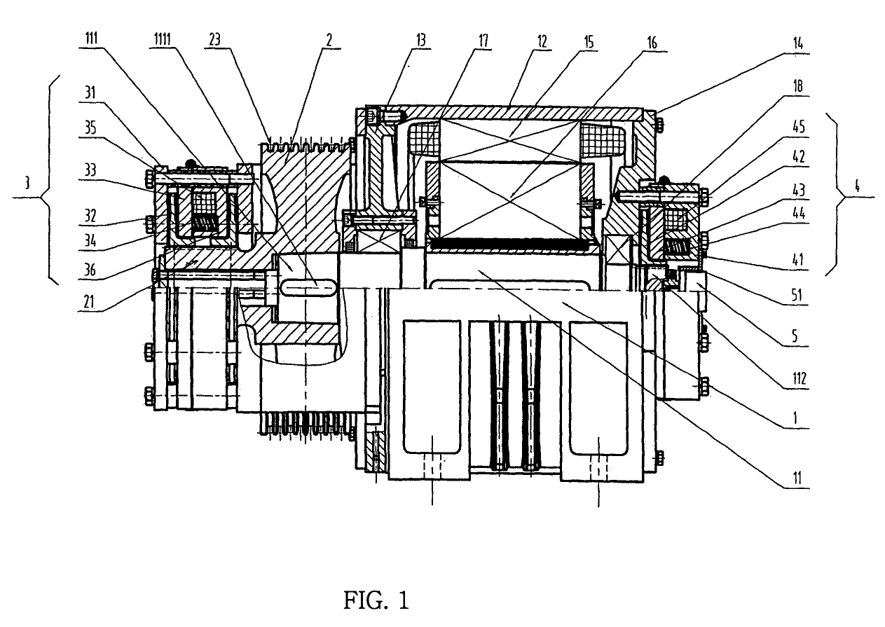

A permanent-magnet synchronous gearless traction machine, depicted in FIG. 1, is simple and reasonable in structure, easy to install, moderate in size but high in load capacity, and is suitable for installation with or without a machine room. With reference to FIG. 1, the permanent-magnet synchronous gearless traction machine includes a permanent-magnet synchronous motor (1) that employs an internal rotor permanent-magnet motor structure that is commonly seen in the industry, and that includes a spindle (11), a base (12), front and rear covers (13, 14), a stator (15), a rotator (16), and front and rear bearings (17, 18), wherein the stator (15) is firmly fitted to the base (12); the rotator (16) and the spindle (11) form an assembly; the spindle (11) is supported on the front and rear covers (13, 14) via the front and rear bearings (17, 18); and the front and rear covers (13, 14) are secured to the base (12) with bolts. In the orientation shown in FIG. 1, a part of a left end of the spindle (11) extending from the main body of the permanent-magnet synchronous motor (1) forms a front shaft extension (111), while a part of a right end of the spindle (11) extending from the main body of the permanent-magnet synchronous motor (1) forms a rear shaft extension (112). A traction wheel (2) is in taper fitting to the front shaft extension (111) via a key (1111) on the front shaft extension (111), so that torque is transferred via the key joint. Here, “taper fitting” refers to the front shaft extension (111) being in a shape of a frustum of a cone, and a hole on the traction wheel (2) for fitting to the front shaft extension (111) matching the shape of the front shaft extension (111) (i.e., a tapered hole is formed), so that the traction wheel (2) can be taper fitted to the front shaft extension (111).

A first brake (3) and a second brake (4) having the same or a similar structure are combined with the traction wheel (2) or directly connected to the spindle (11), respectively; more specifically, the first brake (3) is combined with the traction wheel (2), while the second brake (4) is directly connected to the rear shaft extension (112) of the spindle (11).

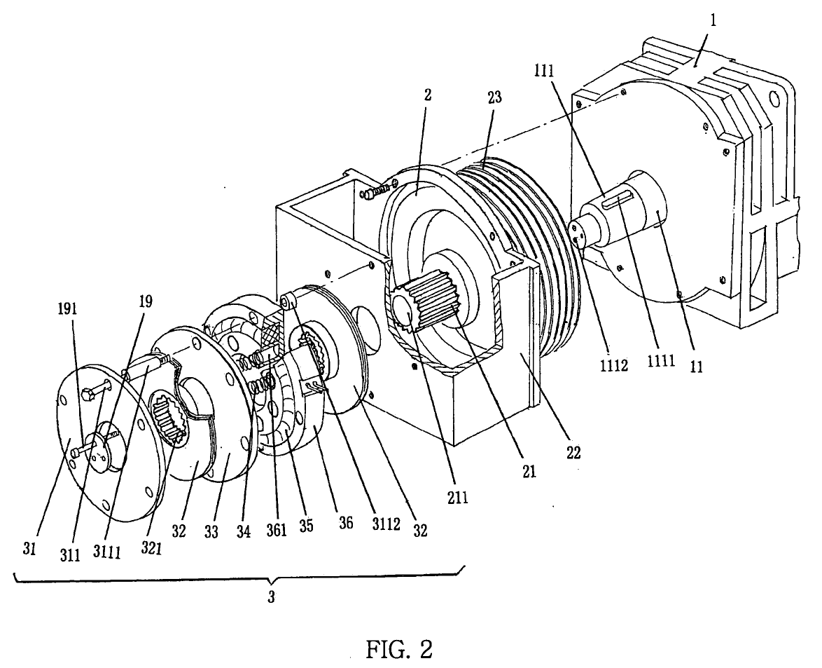

With reference to FIG. 2, and further reference to FIG. 1, an embodiment of direct fitting between the first brake (3) and the traction wheel (2) is depicted, wherein a brake receiver (21) is integrally arranged at a center part on a side of the traction wheel (2) facing the first brake (3), and a cross-section of the brake receiver (21) has essentially an embossed protruding shape. Alternatively, in another embodiment, it is feasible to machine or otherwise form the brake receiver (21) as a structure separate from the first brake (3) and then secure the brake receiver (21) to the traction wheel (2) by bolting, welding, or any other suitable device or method. That is, the brake receiver (21) can be integrally machined or otherwise formed on the traction wheel (2), or it can be a separate part secured rigidly to the traction wheel (2), such as with bolts; in the former case, the first brake (3) will be directly fitted to the traction wheel (2), whereas, in the latter case, the first brake (3) will be fitted to the traction wheel (2) indirectly. In the embodiment shown in FIGS. 1 and 2, the former is chosen.

With further reference to FIG. 2, the first brake (3) includes a fixed disk (31), a pair of front friction disks (32), a front armature (33), one or more front braking springs (34), a front solenoid (35), and a front magnetic yoke (36), wherein, a splined hole (321) is machined out at the center of each front friction disk (32), the splined holes (321) matching a spline on the brake receiver (21). That is, the pair of front friction disks (32) are in spline fitting to the brake receiver (21) that serves as an extension of the traction wheel (2). The fixed disk (31), front armature (33), and front magnetic yoke (36) are secured to a box (22) of the traction wheel (2) with a set of first bolts (311). One of the pair of front friction disks (32) is arranged between the fixed disk (31) and the front armature (33), and the other is arranged on the right of the front magnetic yoke (36) (in the orientation shown in FIG. 2). The front solenoid (35) is embedded in a groove of the front magnetic yoke (36), and a set of front braking springs (34) are arranged in a corresponding set of front spring holes (361) preformed on the front magnetic yoke (36), the front braking springs (34) protruding from the front spring holes (361) to contact the front armature (33). First and second bushings (3111, 3112) are fitted over the first bolts (311) to provide a free gap for the front armature (33) to move back and forth, or axially. The front shaft extension (111) of the spindle (11) of the permanent-magnet synchronous motor (1) passes through the tapered spindle hole on the traction wheel (2) and then enters into a shaft hole (211) on the brake receiver (21). Further, a shaft cap hole (1112) is arranged on an end face of the front shaft extension (111), and the front shaft extension (111) is fixed to a shaft cap (19) with a second bolt (191) in the shaft cap hole (1112).

With further reference to FIG. 1, the second brake (4), in one embodiment, includes a rear friction disk (42), a rear armature (43), a rear braking spring (44), a rear solenoid (45), and a rear magnetic yoke (41), and is fixed to the rear cover (14) of the permanent-magnet synchronous motor (1) with bolts. The rear friction disk (42) is in spline fitting to the rear shaft extension (112) of the spindle (11), so that the braking torque can be transferred through the spline fitting. As shown in FIG. 1, the second brake (4) is almost identical to the first brake (3) in structure, and the only difference is that the fixed disk is used for the rear cover (14) and is directly connected to the rear shaft extension (112) of the spindle (11). Similar to the traction machines in the prior art, a velocity feedback encoder (5) is arranged on the rear shaft extension (112), wherein a rotating part of the velocity feedback encoder (5) rotates with the spindle (11) synchronously, and the casing of the velocity feedback encoder (5) is fixed to the rear magnetic yoke (41) of the second brake (4) via a bracket (51). Alternatively, the rotating part of the velocity feedback encoder (5) can be mounted on the brake receiver (21) that serves as the shaft extension of the traction wheel (2) and rotate with the traction wheel (2) synchronously, and the casing of the velocity feedback encoder (5) can be fixed to the front magnetic yoke (36) of the first brake (3) via a bracket.

### Embodiment 2

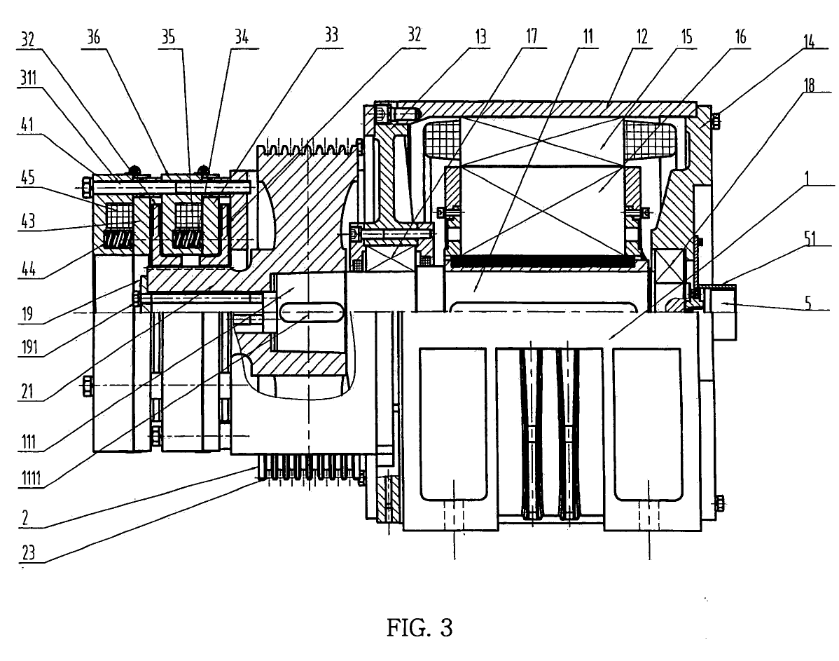

With reference to FIG. 3, in another embodiment, the first and second brakes (3, 4) are fitted in parallel to the brake receiver (21) on the traction wheel (2). In such a case, the fixed disk (31) of the first brake (3) is replaced with the rear magnetic yoke (41) of the second brake (4), and the second brake (4) borrows the left front friction disk (32) of the pair of front friction disks (32) of the first brake (3), eliminating the need for the rear friction disk (42). The casing of the velocity feedback encoder (5) is fixed to the rear cover (14) of the permanent-magnet synchronous motor (1) via the bracket (51). In contrast to Embodiment 1, described above, there is no brake connected to the rear shaft extension (112) of the spindle (11). During the braking process, the first and second brakes (3, 4) brake the traction wheel (2) directly and, therefore, do not need to transfer the braking torque through the spindle (11). Otherwise, Embodiment 2 is substantially similar or identical to the above description of Embodiment 1.

Alternatively, an additional brake may be connected to the rear shaft extension (112) of the spindle (11) as a variant of Embodiment 2, such an embodiment also falling within the protected domain and technical scheme provided in the present invention. That is, as long as at least one brake is combined with the traction wheel (2), such an embodiment shall fall into the protected domain of the present invention.

The working principle of embodiments of the present invention will be described in brief, with reference to FIG. 1 and FIG. 2. The permanent-magnet synchronous motor (1) is mainly designed to produce driving torque. A uniform air gap is formed between an inner surface of the stator (15) in the base (12) and an outer surface of the rotator (16). Further, a permanent-magnet is embedded in the rotator (16). When the coil of the stator (15) is charged with alternating current, an alternating magnetic field will be formed in the air gap, and the alternating magnetic field interacts with the magnetic field produced between the magnetic poles of the permanent-magnet; according to the principle of “opposite magnetic poles attract each other,” a magnetic pole chasing phenomenon occurs, i.e., the magnetic poles of the permanent-magnet chase the magnetic poles of the alternating magnetic field produced by the stator 15, and therefore a rotating torque is produced on the rotator 16. The rotating torque produced on the rotator (16) is transferred via the key (1111) on the front shaft extension (111) of the spindle (11) to the traction wheel (2). A slot (23) is formed on the perimeter of the traction wheel (2), and a steel rope is secured to the slot (23) to tow a carriage. When the traction wheel (2) rotates, the steel rope is dragged under the frictional force between the slot surface of slot (23) and the steel rope, so that the carriage is towed to move up or down.

When the carriage runs normally, the second brake (4) that serves as a service brake is in a charged state, and the rear solenoid (45) is in a charged state. Under the electromagnetic force, the rear armature (43) overrides the spring force of the rear braking spring (44) and closes to the rear magnetic yoke (41), away from the rear friction disk (42). Since the rear friction disk (42) is in spline fitting to the spindle (11), it rotates with the spindle (11) synchronously. When the carriage runs to a docking location, the rear solenoid (45) of the second brake (4) loses power, the rear armature (43) is forced to move to the rear friction disk (42) under the restoring force of a set of rear braking springs (44), and holds the rear friction disk (42) firmly by means of the rear cover (14); therefore, the friction disk (42) is unable to rotate, and therefore produces a braking torque. The braking torque is transferred to the spindle (11), and then transferred through the front shaft extension (111) of the spindle (11) to the traction wheel (2) to force the traction wheel (2) to stop; under the frictional force between the traction wheel (2) and the steel rope, the steel rope that tows the carriage will also stop, and the carriage will stop at the docking location.

When the carriage runs normally, the first brake (3) that serves as an emergency brake is also in a charged state. When the front solenoid (35) in the front magnetic yoke (36) is charged, the front armature (33) will close to the front magnetic yoke (36) under the electromagnetic force, and therefore release the front friction disks (32). Thus the pair of front friction disks (32) will rotate with the traction wheel (2), and the traction wheel (2) will rotate with the spindle (11). In case of sudden power outage, the front solenoid (35) of the first brake (3) will lose power instantaneously, the front armature (33) will be forced to move to a front friction disk (32) under the restoring force of a set of front braking springs (34), and the front armature (33) will hold the front friction disk (32) firmly by means of the fixed disk (31). The other front friction disk (32) functions similarly; that is, the other front friction disk (32) is held by the front magnetic yoke (36) and the brake receiver (21). The braking torque produced by the pair of front friction disks (32) is directly transferred to the traction wheel (2) to stop the traction wheel (2). Under the frictional force between the traction wheel (2) and the steel rope, the steel rope that tows the carriage will stop, and therefore the carriage will stop.

Therefore, according to the present invention, since at least one brake of the pair of first and second brakes (3,4) is combined with the traction wheel (2), the braking torque can be applied directly to the traction wheel (2) without transition through the spindle (11) in case of emergency braking; therefore, the braking is more direct and rapid, and is much safer.

1-8. (canceled)

9. A permanent-magnet synchronous gearless traction machine comprising: a permanent-magnet synchronous motor (1) having a spindle (11); a traction wheel (2) coupled to the spindle (11) of the permanent-magnet synchronous motor (1); a first brake (3); and a second brake (4), wherein at least one of the first brake (3) or the second brake (4) is coupled to the traction wheel (2).

10. The permanent-magnet synchronous gearless traction machine according to claim 9, wherein the first brake (3) is coupled to the traction wheel (2), and the second brake (4) is directly connected to the spindle (11).

11. The permanent-magnet synchronous gearless traction machine according to claim 10, wherein the first brake (3) is directly coupled to the traction wheel (2).

12. The permanent-magnet synchronous gearless traction machine according to claim 10, wherein the first brake (3) is not directly coupled to the spindle (11).

13. The permanent-magnet synchronous gearless traction machine according to claim 9, wherein the first and second brakes (3, 4) are coupled in parallel to the traction wheel (2).

14. The permanent-magnet synchronous gearless traction machine according to claim 13, wherein the first and second brakes (3, 4) are directly coupled to the traction wheel (2).

15. The permanent-magnet synchronous gearless traction machine according to claim 13, wherein the first and second brakes (3, 4) are not directly coupled to the spindle (11).

16. The permanent-magnet synchronous gearless traction machine according to claim 9, wherein the traction wheel (2) includes a brake receiver (21) configured to receive the first brake (3) at a center of a side of the traction wheel (2) facing the first brake (3).

17. The permanent-magnet synchronous gearless traction machine according to claim 16, wherein the brake receiver (21) is integrally arranged at the center of the side of the traction wheel (2).

18. The permanent-magnet synchronous gearless traction machine according to claim 17, wherein the brake receiver (21) has a spline.

19. The permanent-magnet synchronous gearless traction machine according to claim 16, wherein the brake receiver (21) is fixed to the center of the side of the traction wheel (2).

20. The permanent-magnet synchronous gearless traction machine according to claim 19, wherein the brake receiver (21) is bolted to the center of the side of the traction wheel (2).

21. The permanent-magnet synchronous gearless traction machine according to claim 19, wherein the brake receiver (21) has a spline.
